(19) United States
(12) Patent Application Publication
(10) Pub. No.: US 2026/0340340 A1
(43) Pub. Date: Oct. 29, 2026

(54) DECISION MAKING BASED ON INTERDEPENDENCIES BETWEEN DIFFERENT LEVELS RELATED TO AN ANOMALY IN COMMUNICATION NETWORK

(71) Applicant: Telefonaktiebolaget LM Ericsson (publ), Stockholm (SE)

(72) Inventors: Illyyne SAFFAR, Le plessis-Robinson (FR); Apostolos DESTOUNIS, Paris (FR); Osama AROUK, Massy (FR); Adèle HARRISSART, Chatou (FR); Ganesh DEL GROSSO, Bourg-la-Reine (FR)

(73) Assignee: Telefonaktiebolaget LM Ericsson (publ), Stockholm (SE)

(21) Appl. No.: 19/474,553

(22) PCT Filed: Nov. 1, 2023
(86) PCT No.: PCT/SE2023/051098

§ 371 Date: Oct. 10, 2025

(30) Foreign Application Priority Data
Apr. 10, 2023 (GR) 20230100305

(51) Int. Cl. G06N 3/044; G06N 3/08; H04L 41/16

(52) U.S. Cl. CPC G06N 3/044; G06N 3/08; H04L 41/16

(57) ABSTRACT

A computer-implemented method performed by a computing device includes a global machine learning, ML model in a communication network that includes a plurality of different levels. The method includes identifying interdependencies between the plurality of different levels related to at least one anomaly in at least one of the different levels. The method further includes deciding, per level of the plurality of different levels, an action to take responsive to the identification of the interdependencies between the plurality of different levels related to at least one anomaly in at least one of the different levels. Related methods and apparatus are also provided.

### TECHNICAL FIELD

The present disclosure relates generally to computer-implemented methods performed by a computing device to make a decision based on interdependencies between different levels related to at least one anomaly in at least one of the different levels, and related methods and devices.

### BACKGROUND

As complexity of fifth generation (5G) and beyond networks increases, supporting zero-touch in management and orchestration systems is important. Adopting a cloud native paradigm in 5G and beyond networks, on one hand, may bring benefits for mobile networks in terms of system flexibility, scalability, and elasticity, for example. On the other hand, however, it may increase management and orchestration complexity.

System observability is an important process for managing and orchestrating network resources, which may allow network providers to rapidly detect and react to many impediments that can cause network degradation. Some approaches may consider closed-loop automation as a cornerstone for enabling a zero-touch system.

### SUMMARY

There currently exist certain challenges. Some approaches may either detect an anomaly on a specific level of a multiple different level communication network, or detect an anomaly on each level independently for multiple different levels. Such approaches may lack identifying interdependencies between multiple different levels related to an anomaly in at least one of the different levels, and making a decision based on the identified interdependencies between different levels related to the anomaly.

Certain aspects of the disclosure and their embodiments may provide solutions to these or other challenges.

Some embodiments provide a computer-implemented method performed by a computing device comprising a global machine learning, ML, model in a communication network that comprises a plurality of different levels. The method comprises identifying interdependencies between the plurality of different levels related to at least one anomaly in at least one of the different levels. The method further comprises deciding, per level of the plurality of different levels, an action to take responsive to the identification of the interdependencies between the plurality of different levels related to at least one anomaly in at least one of the different levels.

Other embodiments provide a computing device. The computing device comprises a global ML model in a communication network; at least one processor; and at least one memory connected to the at least one processor and storing program code that is executed by the at least one processor to perform operations. The operations comprise to identify interdependencies between the plurality of different levels related to at least one anomaly in at least one of the different levels; and to decide, per level of the plurality of different levels, an action to take responsive to the identification of the interdependencies between the plurality of different levels related to at least one anomaly in at least one of the different levels.

Some embodiments provide a computer program comprising program code to be executed by at least one processor of a computing device comprising a global ML model in a communication network that comprises a plurality of different levels. Execution of the program code causes the computing device to perform operations. The operations comprise to identify interdependencies between the plurality of different levels related to at least one anomaly in at least one of the different levels; and to decide, per level of the plurality of different levels, an action to take responsive to the identification of the interdependencies between the plurality of different levels related to at least one anomaly in at least one of the different levels.

Other embodiments include a computer program product comprising a non-transitory storage medium including program code to be executed by at least one processor of a computing device comprising a global ML model in a communication network that comprises a plurality of different levels. Execution of the program code causes the computing device to perform operations. The operations comprise to identify interdependencies between the plurality of different levels related to at least one anomaly in at least one of the different levels; and to decide, per level of the plurality of different levels, an action to take responsive to the identification of the interdependencies between the plurality of different levels related to at least one anomaly in at least one of the different levels.

Certain embodiments may provide one or more of the following technical advantage(s). Based on identifying interdependencies between a plurality of different levels related to at least one anomaly in at least one of the different levels in a communication network, more complete knowledge of the communication network may be obtained; and a decision can be made, per level, on an action to take responsive to the identification of the interdependencies. As a consequence, the communication network may be proactive, as opposed to reactive, when an anomaly is identified, which may avoid service degradation and/or reduce network operational expenses by having less maintenance. Additional technical advantages may include that the identifying may be automated, which may reduce human intervention and pave a way towards a zero-touch system.

### BRIEF DESCRIPTION OF THE DRAWINGS

The accompanying drawings, which are included to provide a further understanding of the disclosure and are incorporated in and constitute a part of this application, illustrate certain non-limiting embodiments of the present disclosure. In the drawings:

FIG. 1 is a schematic diagram illustrating a closed loop of analytics;

FIG. 2 is a schematic diagram of a European Telecommunications Standards Institute (ETSI) automated closed loop;

FIG. 3 is a schematic diagram illustrating a federated learning setup according to some embodiments;

FIG. 4 is a schematic drawing illustrating a multi-task deep neural network architecture according to some embodiments;

FIG. 5 is a schematic diagram of an example of a deployed system according to some embodiments;

FIG. 6 is a schematic diagram of an example cloud deployment according to some embodiments;

FIG. 7 is schematic diagram of an example O-RAN compliant network deployment according to some embodiments;

FIG. 8 is a flowchart illustrating operations of a computing device according to some embodiments;

FIG. 9 is a block diagram of computing device according to some embodiments;

FIG. 10 is a block diagram of a communication system in accordance with some embodiments;

FIG. 11 is a block diagram of a network node in accordance with some embodiments;

FIG. 12 is a block diagram of a host computer communicating with a user equipment in accordance with some embodiments; and

FIG. 13 is a block diagram of a virtualization environment in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of the present disclosure are shown. Inventive concepts may, however, be embodied in many different forms and should not be construed as limited to the embodiments set forth herein. Rather, these embodiments are provided so that this disclosure will be thorough and complete, and will fully convey the scope of the present disclosure to those skilled in the art. It should also be noted that these embodiments are not mutually exclusive. Components from one embodiment may be tacitly assumed to be present/used in another embodiment.

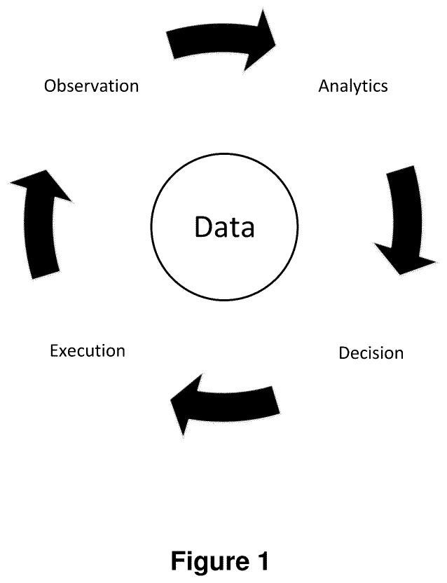

FIG. 1 is a schematic diagram that illustrates a closed loop of analytics discussed in the third generation partnership project (3GPP). See e.g., 3GPP TS 28.104, “Management and orchestration; Management Data Analytics (MDA)”, V17.1.1, page 18 (2022). The closed loop of FIG. 1 includes four components:
Observation, which includes monitoring and collection of events, status and performance of the managed networks and services, and providing observed/collected data to analytics.
Analytics, which includes preparing, processing, and analyzing the observed/collected data (e.g., time series data) related to the managed networks and services. Analytics can provide analytics output that may contain a root cause analysis of ongoing issues, predictions of potential issues and corresponding relevant causes and recommended actions for prevention, and/or prediction of network and/or service demands.
Decision, which includes actions taken based on an analytics reports (provided by Analytics) and other data (e.g., history of previously taken decisions) if necessary. History of decisions may include actions to be taken.
Execution, which includes executions of actions according to the decisions. During an execution step, the actions are carried out by the managed networks and/or services, and reports (e.g. notifications, logs) of the executed actions are provided.

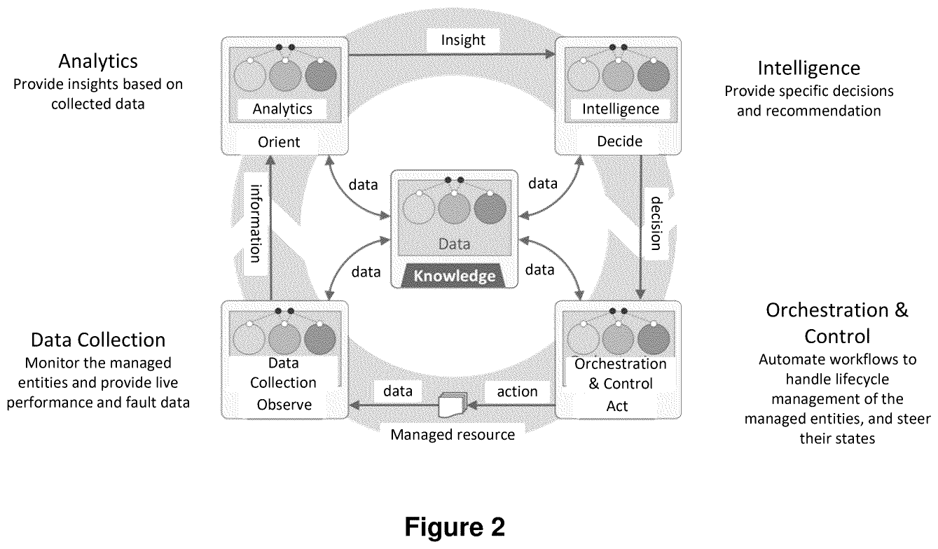

FIG. 2 is a schematic diagram of an ETSI automated closed loop. See e.g., ETSI GS ZSM 002, “Zero-touch network and Service Management (ZSM); Reference Architecture”, V1.1.1, 2019, page 62. In FIG. 2, orchestration & control automates workflows to manage a service (e.g., to handle lifecycle management of managed entities, and steer their states). Data collection is observed (e.g., monitoring managed entities and providing live performance and fault data); information from the collected data is oriented to the appropriate service for analytics, which provide insights based on the collected data; a decision/recommendation is made based on the insight(s); and the orchestration & control takes an act based on the decision. Among the observed data, the orchestrator also can manage anomaly detection in order to take an appropriate decision for an anomaly.

Some approaches include discussion of work on anomaly detection, e.g. in the security context which may rely on single or multi-data sources for anomaly detection. For example, exploiting logging and tracing to try to improve anomaly detection (Bogatinovski, J., Nedelkoski, S., Multi-source Anomaly Detection in Distributed IT Systems, Service-Oriented Computing—ICSOC 2020 Workshops. ICSOC 2020. Lecture Notes in Computer Science, vol 12632, Springer, Cham (2021)); or multi-source data fusion to try to increase accuracy of anomaly detection using artificial intelligence (AI)/ML (Eldardiry, H., Sricharan, K., Liu, J., Hanley, J., Price, B., Brdiczka, O., & Bart, E. Multi-source fusion for anomaly detection: using across-domain and across-time peer-group consistency checks. J. Wirel. Mob. Networks Ubiquitous Comput. Dependable Appl., 5(2), 39-58 (2014)).

In 5G and beyond cloud-native environments, anomaly detection may be performed on multiple levels including, without limitation, for example:
Infra level: central processing unit (CPU), memory, networking, etc.
Service level: quality of service/quality of experience (QoS/QoE)
Application level: e.g., total/dropped packets per second, etc.
Protocol stack level: user datagram protocol (UDP), transmission control protocol (TCP), hypertext transfer protocol (HTTP), etc.
Function level: Logging, tracing, internal functions metrics, etc.
User level: Behavioral metrics indicators, e.g., user mobility
External Enrichment Information (EI): e.g., temperature computing hardware (HW)

Some approaches, such as the International Telecommunication Union Telecommunication Standardization Sector (ITU-T), include some alarms (such as a QoS alarm and a processing error alarm) and recommendations for alarm reporting functions (such as when to send alarm notifications). See e.g., ITU-T Recommendation X.733, ISO/IEC 10164-4: Information technology—Open Systems Interconnection—Systems Management—Alarm reporting function (1992). While a potential correlation with other correlated alarms may be sent, an alarm is raised once an anomaly is happening. It is not clear, however, how such a correlation between alarms is linked, and/or how collaboration between multiple levels may be achieved. See e.g., 3GPP TR 28.830, “Study-on-fault-supervision-evolution”, V0.3.0, (2022).

In another approach, a multi-layer anomaly detection framework may be in the context of a service oriented architecture. Drawbacks of this framework may include: (i) in such a centralized framework, there may be no indication on how to scale the framework in a service oriented architecture, and/or (ii) there may be a lack of data from different layers in cases where observed services are third party components (e.g., in the context of mobile networks when a private part of the network is owned by a third party), for example. See e.g., T. Zoppi, A. Ceccarelli and A. Bondavalli, MADneSs: A Multi-Layer Anomaly Detection Framework for Complex Dynamic Systems, IEEE Transactions on Dependable and Secure Computing, vol. 18, no. 2, pp. 796-809, doi: 10.1109/TDSC.2019.2908366, 1 Mar.-Apr. 2021.

Another approach may include a multi-layer anomaly detection system for intrusion detection in the context of mobile adhoc networks. See e.g., S. Bose, S. Bharathimurugan and A. Kannan, Multi-Layer Integrated Anomaly Intrusion Detection System for Mobile Adhoc Networks, 2007 International Conference on Signal Processing, Communications and Networking, pp. 360-365, doi: 10.1109/ICSCN.2007.350763 (2007). For example, such an approach, may try to detect an anomaly in medium access control (MAC), routing, and application layers independently, and a decision taken by every layer may be weighted and sent to a global node, which may then make a decision whether there is an intrusion. This approach, however, is tailored to an adhoc network, and it may not be adapted to a cloud native environment while considering multiple levels of anomaly detection.

Focusing on detecting an anomaly on only a specific level may not be an optimal way to detect an anomaly because other levels are ignored. Ignored levels may experience a serious anomaly, however, which may, in turn, affect other levels. Detecting an anomaly on each level independently, however, may not be an optimal way to detect an anomaly due to the interdependencies between multiple levels. Having knowledge on all levels may be an important operation to react proactively and in an optimal or improved way. Knowledge on all levels may facilitate paving the way towards a zero-touch system, for example.

Multiple-level (multi-level) anomaly detection that can be adapted to, e.g., a cloud native environment, in a scalable manner may be lacking.

Examples of the present disclosure are discussed in the non-limiting context of end-to-end (E2E) slice and sub-slices use cases (e.g., a radio access network (RAN) or core network (CN) sub slice). For example, a RAN sub-slice (e.g., massive machine-type communications (mMTC), enhanced mobile broadband (eMBB), or ultra-reliable low latency communications (URLLC) sub-slice) may include a radio unit (RU), distributed unit (DU), central unit control plane (CU-CP), and central unit user plane (CU-UP), and the following three levels:
Infra level: CPU, memory
Application level: e.g., number of dropped packets per second
Function level: Logging, tracing, internal functions metrics

An anomaly in the Application level may be related to insufficient memory for a current network function or to an internal error (e.g., an unseen bug in the application implementation) revealed by internal functions metrics, for example. In another example, an anomaly detected on the Function level (e.g., logging or tracing) may or may not affect the other levels. Thus, considering multiple levels at the same time is an important operation for more complete knowledge of the network, and thus to optimize/improve decisions/actions taken by a closed loop at multiple levels/domains, such as the example closed loop in FIG. 2.

There exist certain challenges. An anomaly detection in only one level may not be an optimal way for detecting anomalies. Restricting an anomaly proactive detection to one level may cause/be caused by other anomalies/faults in other level(s). Performing multilevel proactive anomaly detection of different types of anomalies and/or anomalies at different levels (e.g., simultaneously) may be lacking.

Another challenge involves incomplete knowledge of an environment (e.g., a communication network) that may lead to unfair decisions, which may lead to increasing system complexity and service degradation due to reactive actions, and not proactive actions. Solutions may be lacking regarding how to prevent network degradation when handling a reactive action to fix the anomaly including, without limitation, decision making that covers the multiple levels, and/or preventing spread/impact of the anomaly to other levels. In other words, if an anomaly is detected in one level, decision-making handling may be lacking that considers an impact of the anomaly on other levels.

Certain aspects of the disclosure and their embodiments may provide solutions to these or other challenges.

Examples of the present disclosure include multi-level anomaly detection/identification and/or learning an impact of decision-making after an anomaly on other levels.

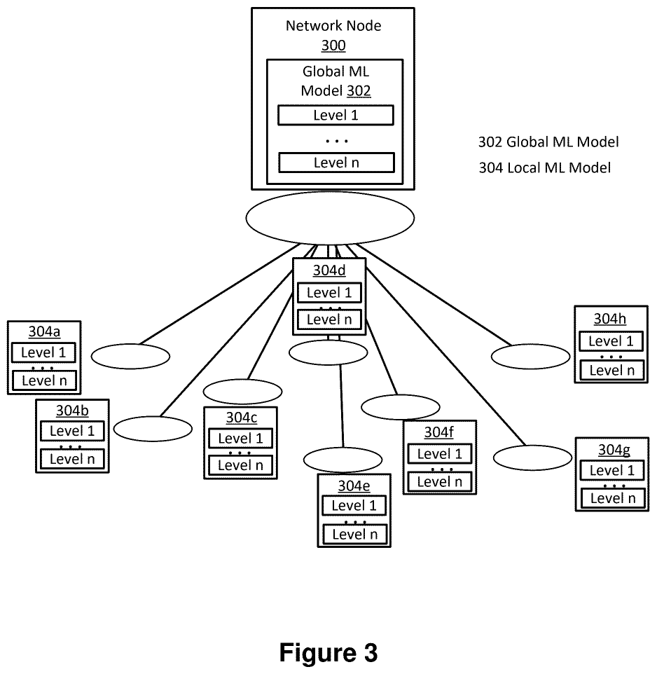

While examples of the present disclosure are discussed in the non-limiting context of multitask based federated learning shown in the examples in FIGS. 3-5, the present disclosure is not limited to federated learning. Instead, other examples include, without limitation, distributed ML and/or decentralized ML.

In the examples in FIGS. 3-5, anomaly detection is based on the illustrated federated learning structure that includes a computing device 300 (also referred to herein as a central node) comprising a global ML model 302 aggregated from local computing devices 304a . . . 304n (anyone of which is referred to herein as a local computing device 304) that respectively comprise a local ML model. This structure allows customization of a respective local computing device 304 according to its context information, as well as keeping data locally without sharing it with the central node 300. This structure can perform anomaly detection and decision making, and can be a centralized or decentralized structure as discussed further herein.

In 3GPP, a focus may either be on anomaly detection at a specific level, such as handover anomaly detection as in open-RAN (O-RAN) (see e.g., O-RAN, “Anomaly detection use case”, https://wiki.o-ran-sc.org/display/RICP/Anomaly+Detection+Use+Case, page 13 (accessed on Mar. 11, 2023), or on fault supervision as in 3GPP TR 28.830, “Study-on-fault-supervision-evolution”, V0.3.0 (2022), for example. However, the decision making does not include the impact of/on other levels. In contrast, examples of the present disclosure include use of a distributed machine learning to learn dependencies/an impact of the decision making, as shown in FIGS. 3-5 for example.

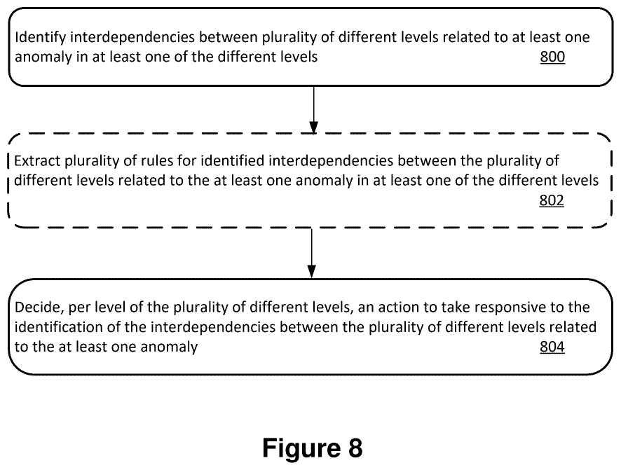

Referring to FIG. 8, some embodiments herein are directed to a computer-implemented method performed by a computing device including a global ML model in a communication network that includes a plurality of different levels. The method includes identifying (800) interdependencies between the plurality of different levels related to at least one anomaly in at least one of the different levels; and deciding (804), per level of the plurality of different levels, an action to take responsive to the identification of the interdependencies between the plurality of different levels related to at least one anomaly in at least one of the different levels.

In some embodiments, the identifying (800) provides knowledge of an impact of the at least one anomaly on the communication network with an objective for the deciding (804) to optimize the action to take responsive to the identification of the interdependencies between the plurality of different levels related to at least one anomaly.

Taking a global decision can introduce a delay on the anomaly detection for individual levels. Taking this into account, examples of the present disclosure also include detecting anomalies and deciding for each level individually. In some embodiments, the global ML model includes a neural network and the identifying (operation 800 in FIG. 8) the interdependencies between the plurality of different levels related to the at least one anomaly includes (i) identifying, per level, whether an anomaly is present, (ii) sharing the identified anomaly between the plurality of different levels, and (iii) outputting an identification of the interdependencies. In some embodiments, the outputting the identification of the interdependencies comprises a root cause analysis of the interdependencies between the plurality of different levels related to the at least one anomaly.

The per level anomaly detection of local computing devices 304 can be done at a higher frequency than global anomaly detection of computing device 300 since different levels (level 1 . . . level n) can output performance data at different frequencies. Likewise, the local ML models can be trained for several iterations before updating the global ML model 302 based on modularity of the global ML model 302.

In some examples, a distributed learning framework is a federated multi-task neural network that performs multi-level anomaly detection. Learning tasks jointly may be beneficial to get a final global ML model 302 that is capable of exploiting the relatedness of tasks to improve its generalization accuracy.

As referred to herein, a “task” refers to a problem where an objective is to solve the problem; and the term “anomaly” refers to an aberration, fault, deviation, abnormality, error, deficiency, etc. in the at least one level.

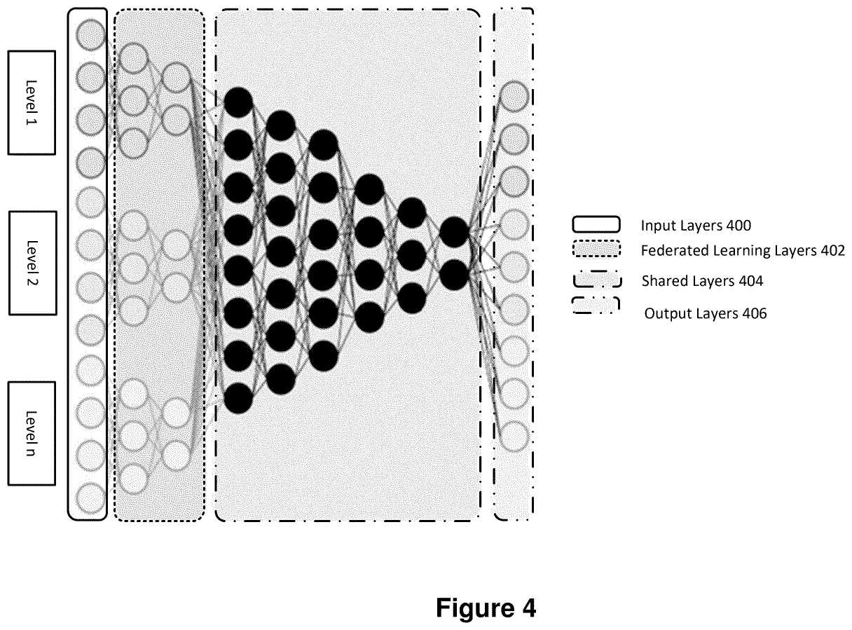

FIG. 4 is a schematic drawing that illustrates an example of a multi-task deep neural network architecture. Multi-task learning (MTL) can be performed with a deep neural network using, e.g., (1) hard-parameter sharing or (2) soft-parameter sharing. A main difference between hard-parameter sharing and soft-parameter sharing includes the way weights are shared inside the deep neural network architecture. Examples of the present disclosure include hard-parameter sharing that includes sharing some of the first hidden layers 402 between tasks while keeping several last output layers 406 exclusive for different tasks.

Using MTL to share knowledge among tasks can be very useful. However, MTL can assume that the tasks are very similar. If this assumption is not verified, then MTL performance for at least some of the tasks may be worse than a single-task model (that is, such a decrease in performance may be referred to as negative transfer and hurt the overall performances). Examples of the present disclosure include similarity of tasks between multiple levels. In some examples, similarity between different levels is assumed because the examples deal with the same task: namely, anomaly detection/identification.

After the local ML models train in distributed learning and global aggregating is performed (e.g., one local ML model per level), some examples include a global MTL model 302 built on top that can detect multilevel anomalies. Referring to the federated learning example in FIG. 4, the first layers 400, 402 are dedicated for each level (level 1 . . . level n). To speed up the learning, first layers 402 (also referred to herein as federated learning layers 402) are taken from the federating learning process per level. Layers 402 can be frozen in the training process of the MTL (see the neurons in the federated learning layers 402). FIG. 4 includes shared layers 404 between different tasks that learn shared knowledge between the different levels (see the neurons in shared layers 404).

In some embodiments, the global ML model comprises a neural network, and the neural network includes (i) a plurality of input layers trained in a federated learning process per level in the plurality of different levels; (ii) a plurality of shared layers between the plurality of input layers and a plurality of output layers. The plurality of shared layers share at least one anomaly and knowledge of an impact of at least one anomaly on the plurality of different levels; and (iii) an output layer comprising a plurality of neurons that respectively correspond to a respective identification of an anomaly per level.

Each output neuron in output layer 406 can include a sigmoid function

$$\hat{y} = σ ( z ) = \frac{1}{1 + {e}^{Z}}$$

where z=Σᵢwᵢxᵢ+bias. The sigmoid function can allow for detecting more than one anomaly at the same time. In some embodiments, a respective neuron in the output layer is activated by a sigmoid function that allows for detection of a plurality of anomalies, and the detection comprises a probability having a value between zero and one and when the value is within a specified range near one the anomaly is present and otherwise the anomaly is not present.

In some embodiments, the extracting (operation 802 of FIG. 8) the plurality of rules includes using a neural network having shared layers that take as inputs the outputs of the neural network for the plurality of different levels.

A global MTL model 302 can help in a global overview of anomalies, and can be used to extract meaningful rules that can be injected as extra knowledge to a decision-making component. For example, in some examples, the learned global MTL model 302 can not only help in global anomaly detection, but also can be used to extract meaningful rules that can be injected as extra knowledge to a decision-making component. Thus, during a proactive decision-making process, interdependencies between levels and also between anomalies and inputs can be taken into account.

In some embodiments, the method further includes extracting (operation 802 in FIG. 8) a plurality of rules for the identified interdependencies between the plurality of different levels related to the at least one anomaly in at least one of the different levels.

Some examples include extracting rules for anomaly detection using a global MTL model 302 that has an architecture with shared layers 404 which takes as inputs the outputs of the DNNs 402 for each level, as illustrated in FIG. 4. The DNN for each level 402 takes as inputs (in input layer 400) relevant features for anomaly detection in a respective level 1 . . . level n, and provides an input to the shared layer 404, and the shared layer 404 provides an input to the output layer 406 for the existence or not of one or more anomalies in each level (e.g., CPU and memory for faults in the Infra level). In some examples, the output is between 0 and 1, with a higher value denoting a higher probability/certainty that there is an anomaly in the corresponding level; and each output of the output layer 406 corresponds to one anomaly type for each of the levels.

The architecture of examples herein can be located in the central computing device 300 of the federated learning setup as shown in FIGS. 3 and 4, and is already trained (as previously discussed), such that the outputs of the federated learning layers 402 and the shared layers 404 are consistent, e.g., there is the same or at least a similar value for the output 406 corresponding to a same anomaly type.

In some examples, a concatenated vector of all inputs (with x^{k} being inputs for level k) is denoted x=[x¹, x², . . . , xⁿ], W is a trainable parameters of the multi-task architecture, and fᵢ(x;W) is the i-th exit of the output layer 406 of the multitask architecture. Then, the procedure can be reverse-engineered to find, for an anomaly in a given level, the inputs in the other levels that are causing the anomaly. In some examples, following equation can be solved to identify an input (or the possible inputs) that solve (with respect to x)

fᵢ(x;W)=1 (Equation 1)

or, alternatively, the optimization problem

$${max}_{x} log {f}_{i} ( x ; W ) \qquad ( Optimization problem 2 )$$

for every output i or the multiple-task architecture. In some embodiments, the extracting (operation 802 in FIG. 8) includes at least one of (i) solving, per output in the output layer of the global ML model, an optimization problem comprising a maximum log function of an input feature to a level and a trainable parameter to identify the input feature that has a value that is equal to or greater than a specified value, and (ii) finding a plurality of solutions to the maximum log function or finding a plurality of local maxima for the following optimization problem

$${max}_{x} log {f}_{i} ( x ; W )$$

per output from the output layer of the global ML model.

The reverse engineering can be performed and the result(s) of the reverse engineering can be used to add decision awareness to a decision-making component as discussed in the following, for example.

In some examples, an objective is to find one solution for Equation (1) or the optimization problem (2) and give the inputs with a value above a specified threshold to the decision-making component. The value of the specified threshold depends on the application and the possible range of the inputs. For example, when the inputs are normalized between 0 and 1, the value of the specified threshold can be equal to 0.5.

In other examples, an objective is to find multiple solutions to equation (1) or multiple (local) maxima for the optimization problem (2); this can be done, for example, by running in N parallel copies of an optimization algorithm, each of them with a different (e.g. random) initialization. In this case, there will be N solutions,

$${x}_{1}^{*} , … , {x}_{N}^{*}$$

to equation (1) or optimization problem (2) after this procedure. The decision-making component can then use these solutions as in the following non-limiting examples:

In some examples, the decision-making component uses the inputs where a solution exists with a value over the specified threshold or with an average value over a specified threshold; in the latter case averaging is done over the N solutions. The specified threshold depends on the application. For example, when the inputs are normalized between 0 and 1, the value of the specified threshold can be equal to 0.5.

In other examples, the decision-making component keeps only a subset of the N vectors. This can be done according to one of the following example criteria (i) in some examples, all N vectors are kept; (ii) in some examples, a specified threshold for the value of the output (e.g.,

$${f}_{i} ( {x}_{n}^{*} ; W )$$

for the n-th solution) is used; and the specific threshold is greater than or equal to 0.5; (iii) in some examples, vectors with an input that exceeds a specified threshold are kept. The specified threshold depends on the application and can be set according to domain knowledge, or to 0.5 if inputs are normalized between 0 and 1 or as the average of the values for this input over the N vectors; or (iv) in some examples, domain knowledge is used to exclude vectors with inputs that do not make sense from a practical perspective or that are known to not cause anomalies (for example, a low traffic load). During operation, the inputs can be forwarded to the decision-making component, and the decision-making component can check whether the vector of inputs matches one of the vectors kept in the subset.

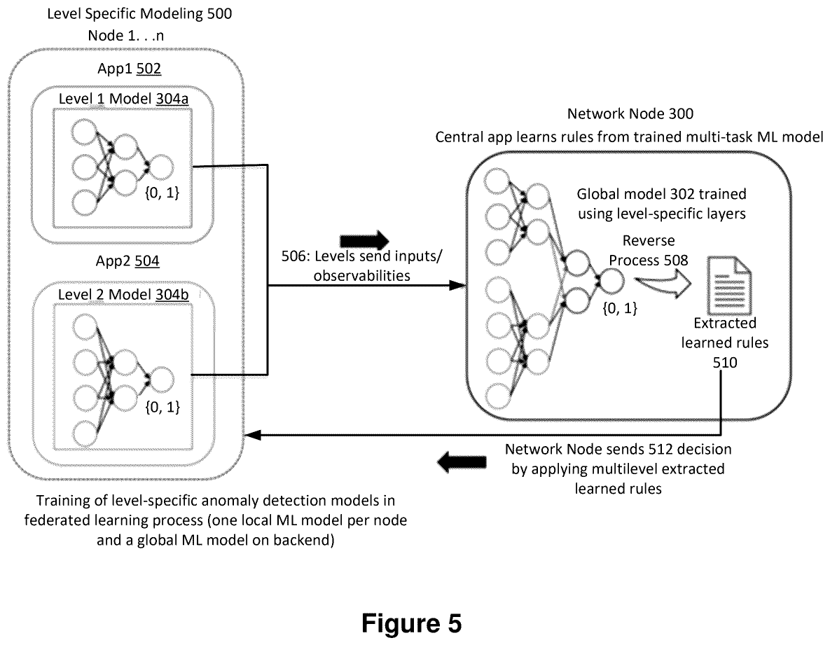

FIG. 5 is a schematic diagram of an example of a deployed system according to some embodiments. In some embodiments, the global ML model is aggregated based on distributed ML. In some embodiments, the distributed ML comprises federated learning (e.g., as shown in FIG. 5). In FIG. 5, two levels are included in level specific modeling 500 for nodes 1 . . . n: Application 1 shown with reference numeral 502 and Application 2 shown with reference numeral 504. The federated learning includes a plurality of local ML models that include a local ML model per respective level of the different levels and the respective local ML models (Level 1 model 304a and Level 2 model 304b in FIG. 5) send in operation 506, to the global ML model 302 of network node 300, an input feature of the respective local ML models 304a, 304b and an observation from the respective local ML models 304a, 304b. The identifying (operation 800 in FIG. 8) includes using the global ML model 302 on the respective input features and observations to identify the interdependencies between the plurality of different levels 502, 504 related to the at least one anomaly.

Operations of examples include: (i) running 500 federated learning per level 502, 504 with local ML models 304a, 304b respectively), (ii) running the global MTL model 302 to cover the multiple levels, and (iii) reversing 508 the MTL in order to extract meaningful rules that can be used for decision making. The reversing 508 of the example of FIG. 5 includes at least one of (i) solving, per output layer of the global ML model 302, an optimization problem comprising a maximum log function of an input feature to a level 502, 504 and a trainable parameter to identify the input feature that has a value that is equal to or greater than a specified value, and (ii) finding a plurality of solutions to the maximum log function or finding a plurality of local maxima for the following optimization problem

$${max}_{x} log {f}_{i} ( x ; W )$$

per output layer of the global ML model 302. In operation 512, the network node 300 sends, to the nodes for the level specific modeling 500, a decision made by applying the extracted rules.

In some examples, the deployment is in the central computing device 300. In some embodiments, the computing device node includes a central computing device in a distributed ML structure.

In some examples, the deployment can be shared and extended to the local models, for example, if the local computing devices 304 are able to make the decision if an anomaly (ies) arise(s).

In some embodiments, a quantity of the plurality of local ML models is scalable.

In some examples, a global MTL model 302 can be run in the architecture of the federated learning. In other words, the global MTL 302 is not built above small local ML models, but rather is trained in a federated way. In some embodiments, the global ML model is included in a federated learning structure and training of the global ML model includes at least one of (i) federated learning is run per level at the plurality of local ML models and the global ML model uses inputs and observations from the plurality of the local ML models, and (ii) training the global ML model on data when a local ML model is not available.

In some embodiments, the plurality of different levels comprises data or information on at least one of (i) different hardware or software levels, (ii) different service levels, (iii) different metrics for an application level, (iv) different protocol stack levels, (v) different functional levels, (vi) different metrics for a user equipment level, and (vii) different external information or enrichment information.

In some embodiments, the communication network includes at least one of a radio access network, RAN, and an open radio access network.

In some embodiments, the computing device includes at least one of a server and a computer.

As previously indicated, certain embodiments may provide one or more of the following technical advantages. Based on detecting an anomaly on any level/many levels at the same time and/or learning an impact of a decision made after each anomaly on other levels' in a federated manner, a complete knowledge on the network may be obtained and, as a consequence, one or more of the following technical advantages may be provided:
Bringing the network from a reactive system to the anomaly to a proactive system in which early anomalies can be detected, which may avoid service degradation due to proactive actions and/or reduce network operating expenses (OPEX) by having less maintenance compared to a fault management system;
Detecting and reacting to an anomaly in an automated way, which may reduce human intervention and pave the way towards zero-touch system;
Extracting layer-specific policies that would have a global effect/impact.
Other technical advantages based on a split of ML model trainings at the different levels may result in distributing the training; re-using the ML model trained at each level; and scalability of the global ML model that can be adapted for federated learning, centralized training, or decentralized training.

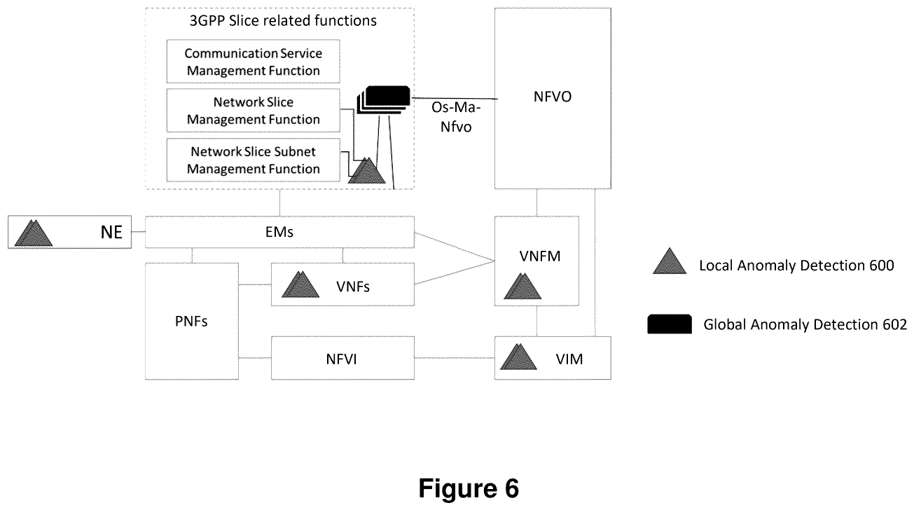

FIG. 6 is a schematic diagram of an example cloud deployment in accordance with some embodiments. The example cloud deployment in FIG. 6 is a 3GPP compatible configuration. As discussed in 3GPP TR 28.861 V16.0.0 (2019-12), for example, 3GPP defines centralized and distributed loops for a self-organized network (SON), which can be used for a federated implementation according to some embodiments. Since operations herein consider multi-level anomaly detection, local levels of the anomaly detection can be implemented in different entities of a virtualized network as shown in the example in FIG. 6. As shown in FIG. 6, the local anomaly detection 600 is distributed over the following network entities: Network slice management function; network slice subnet management function; network entity (NE); virtual network functions (VNFs); virtual network function manager (VNFM); and virtualized infrastructure manager (VIM). Global anomaly detection 602 is located within a 3GPP slice related management functions block, where the global anomaly detection can communicate its decision to a network function virtualization orchestrator (NFVO), which in turn can execute the action(s), and thus can achieve a preventive system.

While the example in FIG. 6 is a 3GPP compatible cloud deployment, examples of the present disclosure are not so limited and include other types of cloud deployments. For example, and without limitation, a cloud deployment can be based on an ETSI compatible network slice management configuration in a network functions virtualization (NFV) framework. See e.g., ETSI GR NFV-EVE 012, “Network Functions Virtualization (NFV) Release 3; Evolution and Ecosystem” V3.1.1 (2017-12).

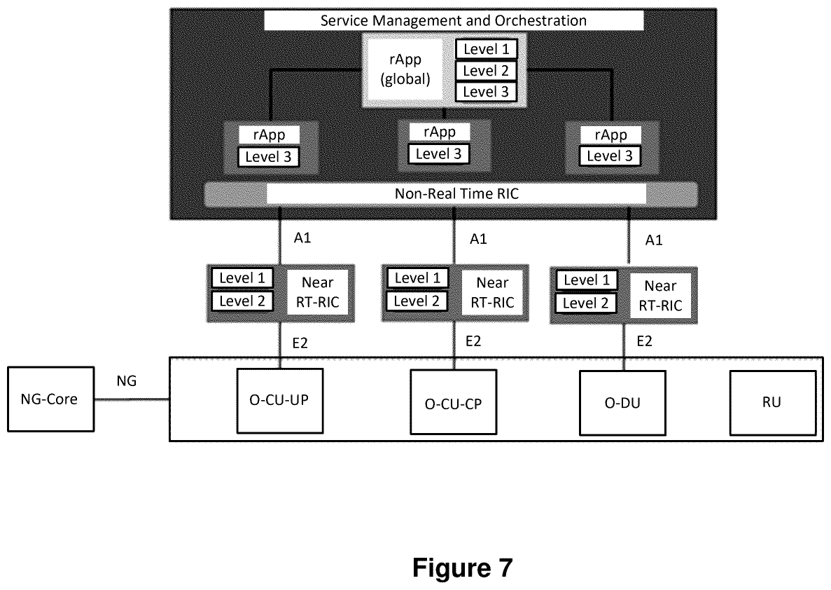

FIG. 7 is schematic diagram of an O-RAN compliant network deployment according to some embodiments. FIG. 7 includes a service management and orchestration framework that includes a global rApp that includes multiple levels. This example O-RAN network includes an O-RAN central unit-control plane (O-CU-CP); an O-RAN distributed unit (O-DU); a near real-time (RT) RAN intelligent controller (RIC); three near RT-RICs; and a RU. A next generation (NG) core is communicatively connected to O-CU-UP, O-CU-CP, O-DU, and RU. FIG. 7 also includes interfaces A1, E2, and NG interfaces as shown.

For ease of discussion, three levels of anomaly detection are included in the example in FIG. 7, but other examples can include different numbers and/or types of levels. The three levels in FIG. 7 are: (i) level 1 represents an App level (e.g., number of dropped packets), (ii) level 2 represents a function level (e.g., logging), and (iii) level 3 represents an infrastructure level (e.g., CPU). In FIG. 7, the local anomaly levels are implemented either on the top of Near-RT RIC (as an xAPP) or on the top of Non-RT RIC (as an rApp), depending on the anomaly level. More specifically, in FIG. 7, the local level 3 is implemented at Non-RT RIC since it is related to the infrastructure level (e.g., CPU) and this data is transported over an O2 interface (e.g., O-RAN standardized interface for management, monitoring, fault tolerance, and update of O-Cloud (e.g., infrastructure)) from O-Cloud (e.g., infrastructure). On the other hand, the local level 1 and local level 2 are implemented on the top of Near-RT RIC, However, the global level in this example is implemented as an rApp on the top of non-RT RIC. Operations of the present disclosure can be implemented via xApps and/or rApps and, thus, the operations are fully compatible with O-RAN specifications.

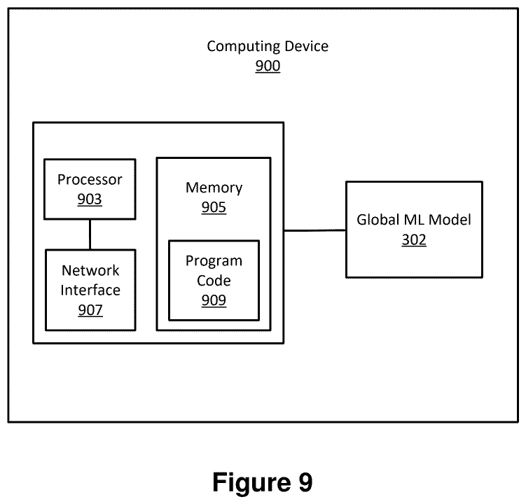

Operations of a computing device can be performed by the computing device 900 of FIG. 9. Operations of the computing device (implemented using the structure of FIG. 9) have been discussed with reference to the flow chart of FIG. 8 according to some embodiments of the present disclosure. Operation 802 from the flow chart of FIG. 8 may be optional with respect to some embodiments of computing devices and related methods. Modules may be stored in memory 905 and/or the global ML model 302 of FIG. 9, for example, and these modules may provide instructions so that when the instructions of a module are executed by respective computing device processor 903 (also referred to herein as processing circuitry), computing device 900 performs respective operations of the flow chart of FIG. 8.

As shown in FIG. 9, the computing device 900 includes processor 903 that is operatively coupled to memory 905, network interface 907, global ML model 302, and/or any other component, or any combination thereof. Certain computing devices may utilize all or a subset of the components shown in FIG. 9. The level of integration between the components may vary from one computing device to another computing device. Further, certain computing devices may contain multiple instances of a component, such as multiple processors, memories, etc.

The processor 903 is configured to process instructions and data and may be configured to implement any sequential state machine operative to execute instructions stored as machine-readable computer programs in the memory 905 and/or global ML model 302. The processor 903 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 903 may include multiple central processing units (CPUs).

In the example, the network interface 907 may be configured to provide an interface or interfaces to an input device, output device, or one or more input and/or output devices. Examples of an output device include a display, a monitor, a printer, another output device, or any combination thereof. An input device may allow a user to capture information into the computing device 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, a force sensor, an optical sensor, a proximity sensor, a biometric sensor, etc., or any combination thereof. An output device may use the same type of interface port as an input device. For example, a Universal Serial Bus (USB) port may be used to provide an input device and an output device.

The memory 905 and/or global ML model 302 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 905 and/or global ML model 302 includes one or more application programs, such as an operating system, web browser application, a widget, gadget engine, or other application, and corresponding data. The memory 905 and/or global ML model 302 may store, for use by the computing device 900, any of a variety of various operating systems or combinations of operating systems.

The memory 905 and/or global ML model 302 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 905 and/or global ML model 302 may allow the computing device 900 to access instructions, application programs and the like, stored on transitory or non-transitory memory media, to off-load data, or to upload data. An article of manufacture, such as one utilizing a communication system may be tangibly embodied as or in the memory 905 and/or global ML model 302 which may be or comprise a device-readable storage medium.

The processor 903 may be configured to communicate with a network using the network interface 907. The network interface 907 may comprise one or more communication subsystems. The network interface 907 may include one or more transceivers used to communicate, such as by communicating with one or more remote transceivers of another device capable of wireless communication (e.g., another computing device, local computing device, edge node, cloud node, etc.). Each transceiver may include a transmitter and/or a receiver appropriate to provide network communications (e.g., optical, electrical, and so forth).

In the illustrated embodiment, communication functions of the network interface 907 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Functions implemented by some embodiments may be virtualized. In the present context, virtualizing means creating virtual versions of apparatuses or computing devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more VMs implemented in one or more virtual environments hosted by one or more of hardware nodes, such as a hardware computing device that operates as an edge node or cloud node. Further, in embodiments the virtual node may be entirely virtualized.

Applications (which may alternatively be called software instances, virtual appliances, network functions, virtual nodes, virtual network functions, etc.) can be run in the virtualization environment to implement some of the features, functions, and/or benefits of some of the embodiments disclosed herein.

Although the computing device described herein may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the computing device, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processor and the network interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In certain embodiments, a computing device (300, 900) is provided. The computing device (300, 900) includes a global ML model (302) in a communication network that includes a plurality of different levels; at least one processor (903); and at least one memory (905) connected to the at least one processor (903) and storing program code that is executed by the at least one processor to perform operations. The operations include to perform some or all of the functionality described herein.

In certain embodiments, a computer program including program code to be executed by a processor (903) of a computing device (300, 900) including a global ML model (302) in a communication network that includes a plurality of different levels. Execution of the program code causes the computing device to perform operations. The operations include to perform some or all of the functionality described herein.

In certain embodiments, a computer program product including a non-transitory storage medium (905, 302) including program code (909) to be executed by a processor (903) of a computing device (300, 900) including a global ML model (302) in a communication network that includes a plurality of different levels. Execution of the program code causes the computing device to perform operations. The operations include to perform some or all of the functionality described herein.

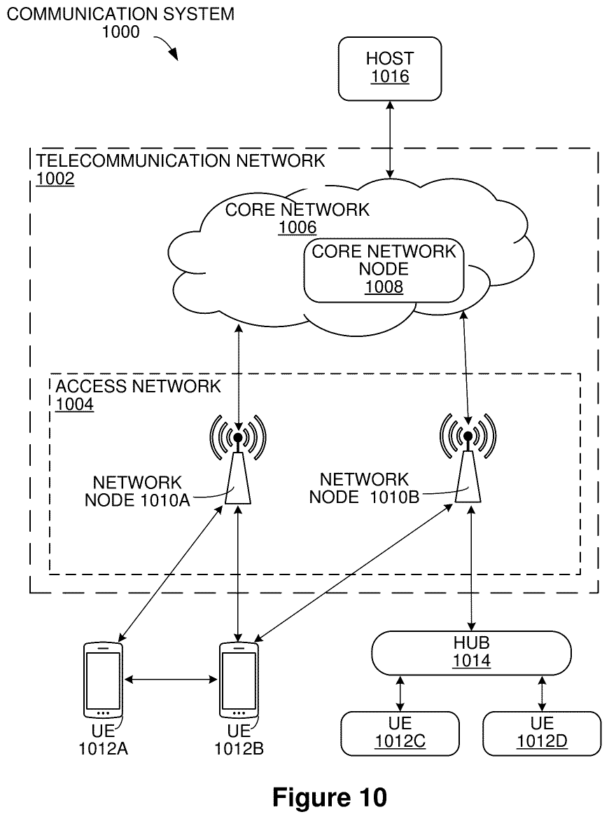

FIG. 10 shows an example of a communication system (also referred to herein as a “communication network”) 1000 in accordance with some embodiments.

In the example, the communication system 1000 (also referred to herein as a communication network) includes a telecommunication network 1002 that includes an access network 1004, such as a RAN, and a core network 1006, which includes one or more core network nodes 1008. The access network 1004 includes one or more access network nodes, such as network nodes 1010a and 1010b (one or more of which may be generally referred to as network nodes 1010), or any other similar 3GPP access node or non-3GPP access point. The network nodes 1010 facilitate direct or indirect connection of user equipment (UE) (also referred to herein as “user device”), such as by connecting UEs 1012a, 1012b, 1012c, and 1012d (one or more of which may be generally referred to as UEs 1012) to the core network 1006 over one or more wireless connections. A computing device (e.g., computing device 300, 900) can be a network node 1010, a UE 1012, or another node comprising a computing device in communication system 1000.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide URLLC services to some UEs, while providing eMBB services to other UEs, and/or mMTC/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

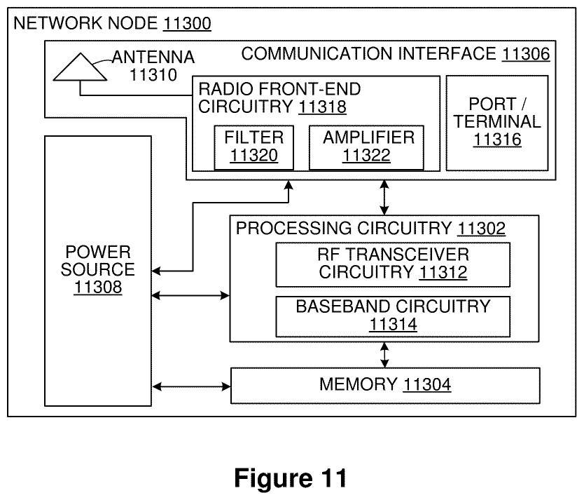

FIG. 11 shows a network node 11300 in accordance with some embodiments. As used herein, network node refers to equipment capable, configured, arranged and/or operable to communicate directly or indirectly with a UE and/or with other network nodes, computing devices, or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), computing devices, O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 11300 includes a processing circuitry 11302, a memory 11304, a communication interface 11306, and a power source 11308. The network node 11300 may be composed of multiple physically separate components (e.g., a NodeB component and a RNC component, or a BTS component and a BSC component, etc.), which may each have their own respective components. In certain scenarios in which the network node 11300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 11300 may be configured to support multiple radio access technologies (RATs). In such embodiments, some components may be duplicated (e.g., separate memory 11304 for different RATs) and some components may be reused (e.g., a same antenna 11310 may be shared by different RATs). The network node 11300 may also include multiple sets of the various illustrated components for different wireless technologies integrated into network node 11300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 11300.

The processing circuitry 11302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 11300 components, such as the memory 11304, to provide network node 11300 functionality.

In some embodiments, the processing circuitry 11302 includes a system on a chip (SOC). In some embodiments, the processing circuitry 11302 includes one or more of radio frequency (RF) transceiver circuitry 11312 and baseband processing circuitry 11314. In some embodiments, the radio frequency (RF) transceiver circuitry 11312 and the baseband processing circuitry 11314 may be on separate chips (or sets of chips), boards, or units, such as radio units and digital units. In alternative embodiments, part or all of RF transceiver circuitry 11312 and baseband processing circuitry 11314 may be on the same chip or set of chips, boards, or units.

The memory 11304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 11302. The memory 11304 may store any suitable instructions, data, or information, including a computer program, software, an application including one or more of logic, rules, code, tables, and/or other instructions capable of being executed by the processing circuitry 11302 and utilized by the network node 11300. The memory 11304 may be used to store any calculations made by the processing circuitry 11302 and/or any data received via the communication interface 11306. In some embodiments, the processing circuitry 11302 and memory 11304 is integrated.

The communication interface 11306 is used in wired or wireless communication of signaling and/or data between a network node, access network, and/or UE. As illustrated, the communication interface 11306 comprises port(s)/terminal(s) 11316 to send and receive data, for example to and from a network over a wired connection. The communication interface 11306 also includes radio front-end circuitry 11318 that may be coupled to, or in certain embodiments a part of, the antenna 11310. Radio front-end circuitry 11318 comprises filters 11320 and amplifiers 11322. The radio front-end circuitry 11318 may be connected to an antenna 11310 and processing circuitry 11302. The radio front-end circuitry may be configured to condition signals communicated between antenna 11310 and processing circuitry 11302. The radio front-end circuitry 11318 may receive digital data that is to be sent out to other network nodes or UEs via a wireless connection. The radio front-end circuitry 11318 may convert the digital data into a radio signal having the appropriate channel and bandwidth parameters using a combination of filters 11320 and/or amplifiers 11322. The radio signal may then be transmitted via the antenna 11310. Similarly, when receiving data, the antenna 11310 may collect radio signals which are then converted into digital data by the radio front-end circuitry 11318. The digital data may be passed to the processing circuitry 11302. In other embodiments, the communication interface may comprise different components and/or different combinations of components.

In certain alternative embodiments, the network node 11300 does not include separate radio front-end circuitry 11318, instead, the processing circuitry 11302 includes radio front-end circuitry and is connected to the antenna 11310. Similarly, in some embodiments, all or some of the RF transceiver circuitry 11312 is part of the communication interface 11306. In still other embodiments, the communication interface 11306 includes one or more ports or terminals 11316, the radio front-end circuitry 11318, and the RF transceiver circuitry 11312, as part of a radio unit (not shown), and the communication interface 11306 communicates with the baseband processing circuitry 11314, which is part of a digital unit (not shown).

The antenna 11310 may include one or more antennas, or antenna arrays, configured to send and/or receive wireless signals. The antenna 11310 may be coupled to the radio front-end circuitry 11318 and may be any type of antenna capable of transmitting and receiving data and/or signals wirelessly. In certain embodiments, the antenna 11310 is separate from the network node 11300 and connectable to the network node 11300 through an interface or port.

The antenna 11310, communication interface 11306, and/or the processing circuitry 11302 may be configured to perform any receiving operations and/or certain obtaining operations described herein as being performed by the network node. Any information, data and/or signals may be received from a UE, another network node and/or any other network equipment. Similarly, the antenna 11310, the communication interface 11306, and/or the processing circuitry 11302 may be configured to perform any transmitting operations described herein as being performed by the network node. Any information, data and/or signals may be transmitted to a UE, another network node and/or any other network equipment.

The power source 11308 provides power to the various components of network node 11300 in a form suitable for the respective components (e.g., at a voltage and current level needed for each respective component). The power source 11308 may further comprise, or be coupled to, power management circuitry to supply the components of the network node 11300 with power for performing the functionality described herein. For example, the network node 11300 may be connectable to an external power source (e.g., the power grid, an electricity outlet) via an input circuitry or interface such as an electrical cable, whereby the external power source supplies power to power circuitry of the power source 11308. As a further example, the power source 11308 may comprise a source of power in the form of a battery or battery pack which is connected to, or integrated in, power circuitry. The battery may provide backup power should the external power source fail.

Embodiments of the network node 11300 may include additional components beyond those shown in FIG. 11 for providing certain aspects of the network node's functionality, including any of the functionality described herein and/or any functionality necessary to support the subject matter described herein. For example, the network node 11300 may include user interface equipment to allow input of information into the network node 11300 and to allow output of information from the network node 11300. This may allow a user to perform diagnostic, maintenance, repair, and other administrative functions for the network node 11300.

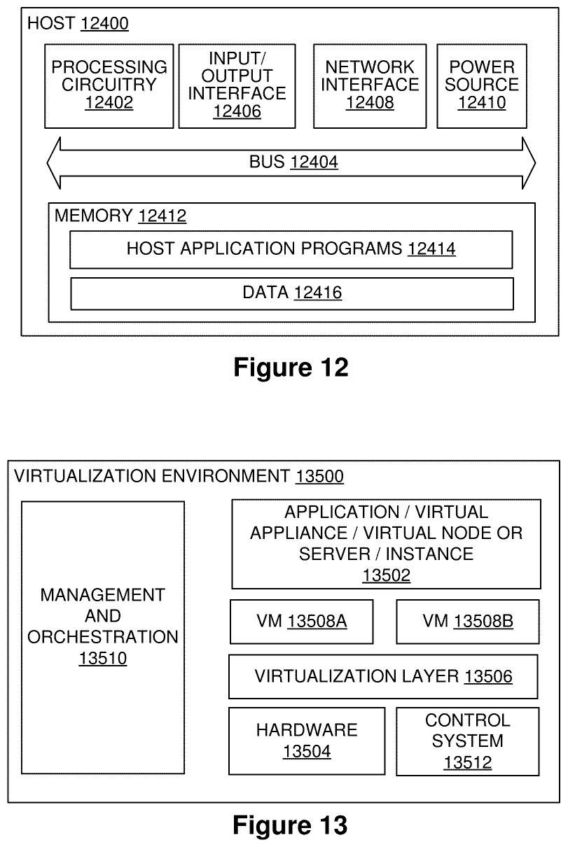

FIG. 12 is a block diagram of a host 12400, which may be an embodiment of the host 10116 of FIG. 10, in accordance with various aspects described herein. As used herein, the host 12400 may be or comprise various combinations hardware and/or software, including a standalone server, a blade server, a cloud-implemented server, a distributed server, a virtual machine, container, or processing resources in a server farm. The host 12400 may provide one or more services to one or more UEs or computing devices.

The host 12400 includes processing circuitry 12402 that is operatively coupled via a bus 12404 to an input/output interface 12406, a network interface 12408, a power source 12410, and a memory 12412. Other components may be included in other embodiments. Features of these components may be substantially similar to those described with respect to the devices of previous figures, such as FIG. 11, such that the descriptions thereof are generally applicable to the corresponding components of host 12400.

The memory 12412 may include one or more computer programs including one or more host application programs 12414 and data 12416, which may include user data, e.g., data generated by a UE for the host 12400 or data generated by the host 12400 for a UE or computing device. Embodiments of the host 12400 may utilize only a subset or all of the components shown. The host application programs 12414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 12414 may also provide for user authentication and licensing checks and may periodically report health, routes, and content availability to a central node, such as a device in or on the edge of a core network. Accordingly, the host 12400 may select and/or indicate a different host for over-the-top services for a UE. The host application programs 12414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 13500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more VMs implemented in one or more virtual environments 13500 hosted by one or more of hardware nodes, such as a hardware network node that operates as a computing device, network node, UE, core network node, or host. Further, in embodiments in which the virtual node does not require radio connectivity (e.g., a core network node or host), then the node may be entirely virtualized.

Applications 13502 (which may alternatively be called software instances, virtual appliances, network functions, virtual nodes, virtual network functions, etc.) are run in the virtualization environment 13500 to implement some of the features, functions, and/or benefits of some of the embodiments disclosed herein.

Hardware 13504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 13506 (also referred to as hypervisors or virtual machine monitors (VMMs)), provide VMs 13508a and 13508b (one or more of which may be generally referred to as VMs 13508), and/or perform any of the functions, features and/or benefits described in relation with some embodiments described herein. The virtualization layer 13506 may present a virtual operating platform that appears like networking hardware to the VMs 13508.

The VMs 13508 comprise virtual processing, virtual memory, virtual networking or interface and virtual storage, and may be run by a corresponding virtualization layer 13506. Different embodiments of the instance of a virtual appliance 13502 may be implemented on one or more of VMs 13508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 13508 may be a software implementation of a physical machine that runs programs as if they were executing on a physical, non-virtualized machine. Each of the VMs 13508, and that part of hardware 13504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 13508 on top of the hardware 13504 and corresponds to the application 13502.

Hardware 13504 may be implemented in a standalone network node with generic or specific components. Hardware 13504 may implement some functions via virtualization. Alternatively, hardware 13504 may be part of a larger cluster of hardware (e.g. such as in a data center or CPE) where many hardware nodes work together and are managed via management and orchestration 13510, which, among others, oversees lifecycle management of applications 13502. In some embodiments, hardware 13504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node, base station, or a computing device. In some embodiments, some signaling can be provided with the use of a control system 13512 which may alternatively be used for communication between hardware nodes and radio units.

Further definitions and embodiments are discussed below.

In the above-description of certain embodiments of the present disclosure, it is to be understood that the terminology used herein is for the purpose of describing particular embodiments only and is not intended to be limiting of the present disclosure. Unless otherwise defined, all terms (including technical and scientific terms) used herein have the same meaning as commonly understood by one of ordinary skill in the art to which concepts of the present disclosure belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of concepts of the present disclosure. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of the present disclosure. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present disclosure. All such variations and modifications are intended to be included herein within the scope of present disclosure. Accordingly, the above disclosed subject matter is to be considered illustrative, and not restrictive, and the examples of embodiments are intended to cover all such modifications, enhancements, and other embodiments, which fall within the spirit and scope of the present disclosure. Thus, to the maximum extent allowed by law, the scope of the present disclosure is to be determined by the broadest permissible interpretation of the present disclosure including the examples of embodiments and their equivalents, and shall not be restricted or limited by the foregoing detailed description.

1. A computer-implemented method performed by a computing device comprising a global machine learning, ML, model in a communication network that comprises a plurality of different levels, the method comprising:
identifying interdependencies between the plurality of different levels related to at least one anomaly in at least one of the different levels; and
deciding, per level of the plurality of different levels, an action to take responsive to the identification of the interdependencies between the plurality of different levels related to at least one anomaly in at least one of the different levels.

2. The method of claim 1, wherein the identifying provides knowledge of an impact of the at least one anomaly on the communication network with an objective for the deciding to optimize the action to take responsive to the identification of the interdependencies between the plurality of different levels related to at least one anomaly.

3. The method of claim 1, wherein the global ML model comprises a neural network and the identifying the interdependencies between the plurality of different levels related to the at least one anomaly comprises (i) identifying, per level, whether an anomaly is present, (ii) sharing the identified anomaly between the plurality of different levels, and (iii) outputting an identification of the interdependencies.

4. The method of claim 3, wherein the outputting the identification of the interdependencies comprises a root cause analysis of the interdependencies between the plurality of different levels related to the at least one anomaly.

5. The method of claim 1, further comprising:
extracting a plurality of rules for the identified interdependencies between the plurality of different levels related to the at least one anomaly in at least one of the different levels.

6. The method of claim 3, wherein the neural network comprises (i) a plurality of input layers trained in a federated learning process per level in the plurality of different levels, (ii) a plurality of shared layers between the plurality of input layers and a plurality of output layers, wherein the plurality of shared layers share the at least one anomaly and knowledge of an impact of the at least one anomaly on the plurality of different levels, and (iii) an output layer comprising a plurality of neurons that respectively correspond to a respective identification of an anomaly per level.

7. The method of claim 6, wherein a respective neuron in the output layer is activated by a sigmoid function that allows for detection of a plurality of anomalies, and the detection comprises a probability having a value between zero and one and when the value is within a specified range near one the anomaly is present and otherwise the anomaly is not present.

8. The method of claim 5, wherein the extracting the plurality of rules comprises using a neural network having shared layers that take as inputs the outputs of the neural network for the plurality of different levels.

9. The method of claim 5, wherein the extracting comprises at least one of (i) solving, per output in the output layer of the global ML model, an optimization problem comprising a maximum log function of an input feature to a level and a trainable parameter to identify the input feature that has a value that is equal to or greater than a specified value, and (ii) finding a plurality of solutions to the maximum log function or finding a plurality of local maxima for the following optimization problem
$${max}_{x} log {f}_{i} ( x ; W )$$
per output from the output layer of the global ML model.

10. The method of claim 1, wherein global machine learning, ML, model is aggregated based on distributed ML.

11. The method of claim 10, wherein the distributed ML comprises federated learning and (i) the federated learning comprises a plurality of local ML models that include a local ML model per respective level of the different levels and the respective local ML models send, to the global ML model, an input feature of the respective local ML models and an observation from the respective local ML models, and (ii) the identifying (800) comprises using the global ML model on the respective input features and observations to identify the interdependencies between the plurality of different levels related to the at least one anomaly.

12. The method of claim 1, wherein the computing device node comprises a central computing device in a distributed ML structure.

13. The method of claim 11, wherein a quantity of the plurality of local ML models is scalable.

14. The method of claim 1, wherein the global ML model is included in a federated learning structure and training of the global ML model comprises at least one of (i) federated learning is run per level at the plurality of local ML models and the global ML model uses inputs and observations from the plurality of the local ML models, and (ii) training the global ML model on data when a local ML model is not available.

15. The method of claim 1, wherein the plurality of different levels comprises data or information on at least one of (i) different hardware or software levels, (ii) different service levels, (iii) different metrics for an application level, (iv) different protocol stack levels, (v) different functional levels, (vi) different metrics for a user equipment level, and (vii) different external information or enrichment information.

16. The method of claim 1, wherein the communication network comprises at least one of a radio access network, RAN, and an open radio access network.

17. (canceled)

18. A computing device comprising:
a global machine learning, ML, model in a communication network that comprises a plurality of different levels;
at least one processor;
at least one memory connected to the at least one processor and storing program code that is executed by the at least one processor to perform operations comprising:
identify interdependencies between the plurality of different levels related to at least one anomaly in at least one of the different levels; and
decide, per level of the plurality of different levels, an action to take responsive to the identification of the interdependencies between the plurality of different levels related to at least one anomaly in at least one of the different levels.

19. The computing device of claim 18, wherein the operation to identify provides knowledge of an impact of the at least one anomaly on the communication network for the deciding to optimize the action to take responsive to the identification of the interdependencies between the plurality of different levels related to at least one anomaly.

20. (canceled)

21. (canceled)

22. A computer program product comprising a non-transitory storage medium including program code to be executed by at least one processor of a computing device comprising a global machine learning, ML, model (302) in a communication network that comprises a plurality of different levels, whereby execution of the program code causes the computing device to perform operations comprising:
identify interdependencies between the plurality of different levels related to at least one anomaly in at least one of the different levels; and
decide, per level of the plurality of different levels, an action to take responsive to the identification of the interdependencies between the plurality of different levels related to at least one anomaly in at least one of the different levels.

23. The computer program product of claim 22, wherein the global ML model comprises a neural network and the operation to identify the interdependencies between the plurality of different levels related to the at least one anomaly comprises (i) identifying, per level, whether an anomaly is present, (ii) sharing the identified anomaly between the plurality of different levels, and (iii) outputting an identification of the interdependencies.
